(19) United States
(12) Patent Application Publication
(10) Pub. No.: US 2026/0277156 A1
(43) Pub. Date: Sep. 17, 2026

(54) DEVICE AND SYSTEM INCLUDING A SECURITY HOLOGRAM AND A PROPHYLAXIS FOR DELIVERING A GRATUITY

(71) Applicant: Harris Co. LLC, Denver, CO (US)

(72) Inventor: Coliln Andrew Harris, Denver, CO (US)

(73) Assignee: Harris Co. LLC, Denver, CO (US)

(21) Appl. No.: 19/567,919

(22) Filed: Mar. 16, 2026

Related U.S. Application Data
(63) Continuation-in-part of application No. 17/084,137, filed on Oct. 29, 2020, now abandoned.
(60) Provisional application No. 62/928,245, filed on Oct. 30, 2019.

(51) Int. Cl. G03H 1/00

(52) U.S. Cl. CPC G03H 1/0011

(57) ABSTRACT

A device including a security hologram and a prophylaxis and a system for providing a gratuity is disclosed. The system includes a mobile computing device including one or more processors and memory holding computer program instructions executable by the one or more processors. The computer-implemented program instructions reads a machine-readable code in a hotel room and transmits the machine-readable code and an indication of a gratuity amount including a gratuity sender source of funds account to a service provider.

### CROSS REFERENCE TO RELATED APPLICATIONS

This application claims the benefit of priority under 35 U.S.C. § 120 and is a continuation-in-part of U.S. patent application Ser. No. 17/084,137, filed Oct. 29, 2020, which claims the benefit of priority under 35 U.S.C. § 119 from U.S. Provisional Patent Application Ser. No. 62/928,245, filed Oct. 30, 2019, the disclosures of which are hereby incorporated by reference in their entirety for all purposes.

### BACKGROUND

Lodgers leave cash gratuities for cleaning and maintenance services provided by maids and other service providers in hotels, motels, and private lodgings. This process of providing a cash gratuity to service providers has several problems. Cash can be misplaced or easily lost during the cleaning of a room. Lodgers may desire to leave a gratuity but may not have cash available as they are checking out. A further problem in hotels, motels, and private lodgings is sanitation. Lodgers can be vectors for infectious diseases, microbes, and viruses. Finally, any system that involves the exchange of funds includes security risks. For these and other reasons there is a need for the subject matter of the present disclosure.

### SUMMARY

Consistent with the disclosed embodiments, a system for providing a gratuity is disclosed. The system comprises a mobile computing device including one or more processors and memory holding computer program instructions executable by the one or more processors to read a machine-readable code in a hotel room and transmit the machine-readable code and an indication of a gratuity amount including a gratuity sender source of funds account to a service provider. In some embodiments, the coaster includes the machine-readable code. In some embodiments, the coaster includes a recyclable material. In some embodiments, the recyclable material includes a surface that repels viruses. In some embodiments, the machine-readable code includes a hologram. In some embodiments, the system further comprises a server including one or more processors and memory holding computer program instructions executable by the one or more processors to receive the machine-readable code and the indication of the gratuity amount including the gratuity sender source of funds account and to calculate a net gratuity amount and a service fee amount and to transfer the net gratuity amount to an account associated with a gratuity receiver institution and the service fee amount to an account associated with the service provider. In some embodiments, the coaster includes an advertisement. In some embodiments, the system further comprises a server including one or more processors and memory holding computer program instructions executable by the one or more processors to receive the machine readable code and the indication of the gratuity amount including the gratuity sender source of funds account and to calculate a net gratuity amount and a service fee amount and to transfer the net gratuity amount to an account associated with a gratuity receiver institution and the service fee amount to an account associated with the service provider.

Consistent with the disclosed embodiments, a system for processing an account of a hotelier. The system comprises a mobile computing device to read a machine-readable code associated with a hotelier and transmit the machine-readable code to a service provider. The system further comprises a server associated with the service provider and including machine readable instructions to receive the machine-readable code and further process an account of the hotelier. In some embodiments, the mobile computing device includes a cell phone. In some embodiments, the machine-readable code is included in a coaster. In some embodiments, a hologram includes the machine-readable code.

Consistent with the disclosed embodiments, a method for providing a service to receive a gratuity from a gratuity sender and track a net gratuity amount for a gratuity receiver institution and a service fee amount for a service provider is disclosed. The method comprises creating a gratuity receiver account for the gratuity receiver institution and associating a machine-readable code with the gratuity receiver account. The method comprises providing the machine-readable code to the gratuity receiver institution to enable the gratuity receiver institution to provide the machine-readable code to a gratuity sender. The method comprises receiving the machine-readable code and an indication of a gratuity amount from the gratuity sender, creating a gratuity sender account, and crediting the gratuity sender account with the gratuity amount. The method comprises processing the gratuity amount to generate a net gratuity amount and a service fee amount. The method comprises debiting the gratuity sender account by the gratuity amount, crediting the gratuity receiver account associated with the machine-readable code with the net gratuity amount, and crediting a service provider account associated with the service provider with the service fee amount. In some embodiments, the machine-readable code to the gratuity receiver institution to enable the gratuity receiver institution to provide the machine-readable code to the gratuity sender comprises providing the machine-readable code on coaster. In some embodiments, providing the machine-readable code on the coaster comprises providing a hologram representation of the machine-readable code. In some embodiments, providing the hologram representation or the machine-readable code comprises providing a color hologram representation of the machine-readable code.

Consistent with the disclosed embodiments, a method for processing a gratuity is disclosed. The computer implemented method comprises receiving instructions to transfer a gratuity amount from a gratuity sender having a gratuity sender source of funds account to a gratuity receiver institution having a gratuity receiver institution account and a service provider having a service provider account, the instructions including a machine-readable code associated with the gratuity receiver institution. The method comprises processing the gratuity amount to generate a net gratuity amount and a service fee amount. The method comprises transferring the net gratuity amount from the gratuity sender source of funds account to the gratuity receiver institution account and the service fee amount to the service provider account. In some embodiments, the method further comprises maintaining a running log of transactions for the gratuity receiver institution. In some embodiments, the method further comprises maintaining a running log of transactions for the service provider. In some embodiments, the method further comprises maintaining a running log of transactions for the gratuity sender.

Consistent with the disclosed embodiments, a computer-implemented method for displaying screens in a gratuity collection system is disclosed. The method comprises providing for transition from a state 1 to a state 2, a state 3, a state 6a, a state 6b, or a state 7. The method comprises providing for transition from the state 2 to the state 6a. The method comprises providing for transition from the state 3 to a state 4 or the state 6b. The method comprises providing for transition from the state 4 to a state 5. The method comprises providing for transition from the state 5 to the state 1 or the state 3. The method comprises providing for transition from the state 6a to the state 2. The method comprises providing transition from the state 6b to the state 3. The method comprises providing for transition from the state 7 to the state 4. And the method comprises wherein the state 1 includes displaying on the mobile device a LOGIN SCREEN, the state 2 includes displaying on the mobile device a HOTEL ACCOUNT HOME SCREEN, the state 3 includes displaying on the mobile device a TIPPER ACCOUNT HOME SCREEN, the state 4 includes displaying on the mobile device a MACHINE READABLE CODE SCAN SCREEN, the state 5 includes displaying on the mobile device a TIP ELECTION SCREEN, the state 6a includes displaying on the mobile device a NEW HOTEL ACCOUNT SCREEN, the state 6b includes displaying on the mobile device a NEW TIPPER ACCOUNT SCREEN, and the state 7 includes displaying on the mobile device a ONE TIME TIP SCREEN.

Consistent with the disclosed embodiments, a computer-implemented method for tipping a service provider. The method comprises downloading a tipping application. The method comprises creating a user account for a one-tine payment using the tipping application. The method comprises scanning a machine-readable code identifying a hotelier using the tipping application. And the method comprises selecting a tip for the service provider using the tipping application. In some embodiments, selecting the tip for the service provider using the tipping application comprises selecting an option to provide the tip in cryptocurrency. In some embodiments, the method further comprises receiving the one-time payment by a team lead and the team lead routing a service provider tip to one or more service providers.

Consistent with the disclosed embodiments, a device is disclosed. The device includes a coaster or other structure. The coaster or other structure is formed from a recyclable material. The coaster or other structure has a surface and a security hologram formed on the surface. A machine readable code formed on the surface, and an advertisement is included in the coaster or other structure. In some embodiments, the device further comprises an antimicrobial material formed on the surface, the antimicrobial material to provide a prophylaxis. In some embodiments, the antimicrobial material kills Escherichia coli.

Consistent with the disclosed embodiments, a method for creating one or more computer programs for a system for providing a gratuity to a service provider in a motel or hotel is disclosed. The method includes selecting an artificial intelligence code generating system; and prompting the artificial intelligence code generating system with one or more prompts to generate one or more computer program for the system for providing the gratuity to the service provider in the motel or hotel. In some embodiments, the method when prompting the artificial intelligence code generating system with one or more prompts to generate the one or more computer programs for the system for providing the gratuity to the service provider in the motel or hotel comprises providing the one or more prompts to effect at least the following method: reading a security hologram from a coaster or other structure using a communication device; verifying the security hologram in the communication device; terminating the program if the security hologram is not verified; and passing information from the communication device to a server, if the security hologram is verified.

Consistent with the disclosed embodiments, a system is disclosed. The system includes a mobile computing device including one or more processors and a memory holding computer program instructions executable by the one or more processors to read a machine-readable code in a hotel room and transmit the machine-readable code and an indication of a gratuity amount including a gratuity sender source of funds account to a service provider. A coaster includes the machine-readable code, the coaster includes a recyclable material, the recyclable material includes a surface that repels viruses, the machine-readable code includes a security hologram, and the coaster includes an advertisement.

### BRIEF DESCRIPTION OF THE DRAWINGS

FIG. 1A shows a block diagram of a system in accordance with some embodiments of the present disclosure;

FIG. 1B show an illustration of a machine-readable code included with a coaster in accordance with some embodiments of the present disclosure;

FIG. 2 shows a flow diagram of a computer implemented method for providing a service to receive a gratuity from a gratuity sender and track a net gratuity amount for a gratuity receiver institution and a service fee amount for a service provider in accordance with some embodiments of the present disclosure;

FIG. 3 shows a flow diagram of a computer implemented method for processing a gratuity in accordance with some embodiments of the present disclosure;

FIG. 4 shows a flow diagram of a computer implemented method for displaying screens in a gratuity collection system in accordance with some embodiments of the present disclosure;

FIG. 5 shows a state diagram for the computer-implemented method for displaying screens in the gratuity collection system shown in FIG. 4 in accordance with some embodiments of the present disclosure;

FIGS. 6A, 6B, 6C, 6D, 6E, 6F, 6G, and 6H show exemplary screens suitable for use in connection with implementing the state diagram shown in FIG. 5 in accordance with some embodiments of the present disclosure;

FIG. 7 shows a computer-implemented method for tipping a service provider in accordance with some embodiments of the present disclosure;

FIG. 8 shows exemplary information for collection at the NEW HOTEL ACCOUNT SCREEN shown in FIG. 6F in accordance with some embodiments of the present disclosure;

FIG. 9 shows exemplary information for collection at the NEW TIPPER ACCOUNT SCREEN shown in FIG. 6G in accordance with some embodiments of the present disclosure;

FIG. 10 shows an exemplary coaster layout for the system shown in FIG. 1B in accordance with some embodiments of the present disclosure;

FIG. 11 shows a block diagram of one embodiment the mobile computing device shown in FIG. 1A in accordance with some embodiments of the present disclosure;

FIG. 12 shows an illustration of Screen 1, New User Landing, in accordance with some embodiments of the present disclosure;

FIG. 13 shows an illustration of Screen 2, Existing User Login, in accordance with some embodiments of the present disclosure;

FIGS. 14A to 14B shows an illustration of Screen 3a and 3b, New Accounts, in accordance with some embodiments of the present disclosure;

FIGS. 15A to 15C shows an illustration of Screen 4a, 4b, and 4c, User Home Pages, in accordance with some embodiments of the present disclosure;

FIGS. 16A to 16C shows an illustration of Screens 5a, 5b, and 5c, Information Update, in accordance with some embodiments of the present disclosure;

FIG. 17 shows an illustration of Screen 6, MRC Scan, in accordance with some embodiments of the present disclosure;

FIGS. 18A and 18B show an illustration of Screen 7, Tip Election Screen, and an illustration of Screen 7a, Verification Screen, in accordance with some embodiments of the present disclosure;

FIGS. 19A and 19B show an illustration of Screen 8, New Housekeepers, and a related screen in accordance with some embodiments of the present disclosure;

FIGS. 20A and 20B show an illustration of Screen 9, Split Tips, and a related screen in accordance with some embodiments of the present disclosure;

FIG. 21 shows a state diagram of transitions among Screens 1 to 9 in accordance with some embodiments of the present disclosure;

FIG. 22 shows an illustration of an MRC Card in accordance with some embodiments of the present disclosure; and

FIG. 23 shows an illustration of a device in accordance with some embodiments of the present disclosure.

### DESCRIPTION

Reference will now be made in detail to the exemplary embodiments of the present disclosure described below and illustrated in the accompanying drawings. Wherever possible, the same reference numbers will be used throughout to refer to same or like parts.

While the present invention is described herein with reference to illustrative embodiments for particular applications, it should be understood that the invention is not limited thereto. Those having ordinary skill in the art and access to the teachings provided herein will recognize additional modifications, applications, embodiments, and substitution of equivalents, that all fall within the scope of the disclosure. Accordingly, the disclosure is not to be considered as limited by the foregoing or following descriptions.

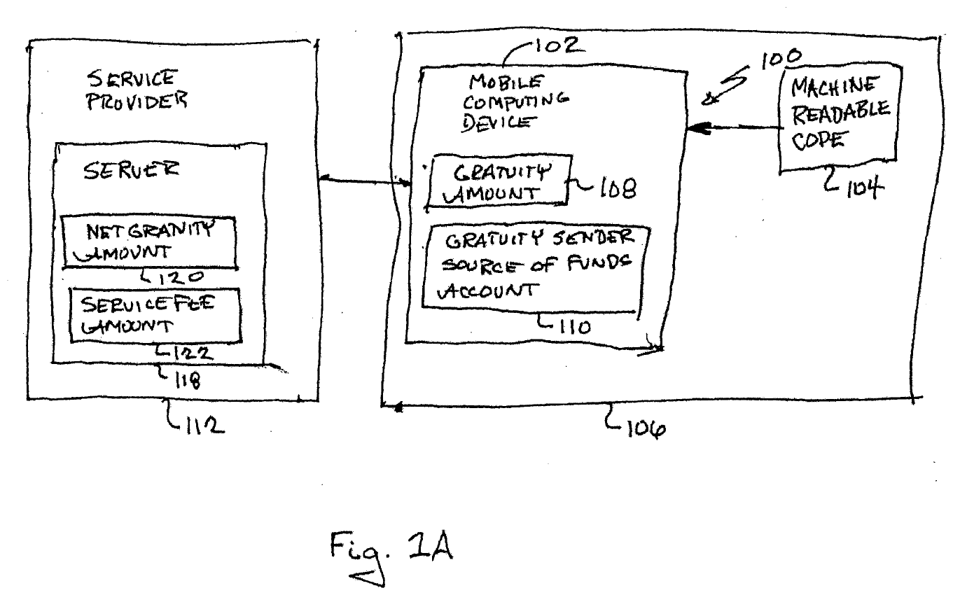

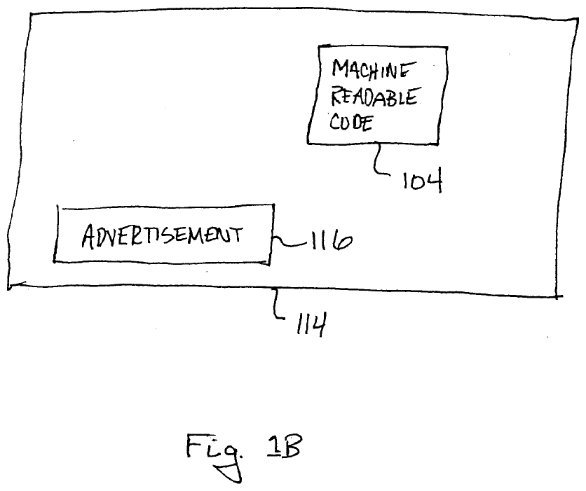

FIG. 1A shows a block diagram of a system 100 in accordance with some embodiments of the present disclosure. The system 100 includes a mobile computing device 102 including one or more processors and memory holding computer program instructions executable by the one or more processors to read a machine-readable code 104 in a hotel room 106 and transmit the machine-readable code 104 and an indication of a gratuity amount 108 including a gratuity sender source of funds account 110 to a service provider 112. The hotel room 106 is not limited to a room in a hotel. The hotel room 106 includes any room provided in the hospitality or lodging industries including but not limited to rooms provided in motels, hotels, and privately rented properties.

The mobile computing device 102 is a portable device capable of operating, executing, and providing services, such as communication services, and applications including those provided by a typical computing device, such as a personal computer or laptop computer. The mobile computing device 102 is not limited to a particular type of mobile computing device. A cell phone is one exemplary mobile computing device suitable for use as the mobile computing device 102 in connection with the system 100.

The machine-readable code 104 is associated with a hotel, motel or other lodging or hospitality provider. The machine-readable code 104 is not limited to a particular type of machine-readable code. Exemplary machine-readable codes suitable for use in connection with the system 100 include bar codes and matrix codes. A bar code is a code including a group of printed and patterned bars and spaces and symbols that is designed to be scanned and read into computer memory and that contains information (such as identification), for example, information identifying a lodging proprietor of the hotel room 106. A matrix code is a two-dimensional code that stores data both horizontally and vertically.

FIG. 1B show an illustration of the machine-readable code 104 included with a substrate 114 in accordance with some embodiments of the present disclosure. In some embodiments, the machine-readable code 104 is imprinted, formed, or mounted on the substrate 114, such as a coaster. A coaster is a mat or small tray placed under a bottle or glass to protect the table or other surface underneath. In some embodiments the substrate 114 is formed from a recyclable material that, when discarded, can be made into new products. Exemplary recyclable materials suitable for use in the fabrication of the substrate 114 include aluminum, steel, cardboard, paper, glass, and plastic. In some embodiments, the recyclable material includes a surface that repels viruses. In some embodiments, the virus is included in a liquid. In some embodiments, the substrate 114 includes an advertisement 116, such as an advertisement for a local nightclub or tavern. In some embodiments, the machine-readable code 104 includes a hologram. A hologram is a three-dimensional image formed by the interference of light beams from a laser or other coherent light source or photograph of an interference pattern which, when suitably illuminated, produces a three-dimensional image.

Referring again to FIG. 1A, in operation, the computer program instructions running on the mobile computing device 102 read the machine-readable code 104 and transmits the machine-readable code 104 and an indication of a gratuity amount 108 including a gratuity sender source of funds account 110 to the service provider 112. The service provider 112 can receive the information on any convenient device including but not limited to cell phone, server, cloud computer system, and digital radio.

In some embodiments, the system 100 further includes a server 118 including one or more processors and memory holding computer program instructions executable by the one or more processors to receive the machine-readable code 104 and the indication of the gratuity amount 108 including the gratuity sender source of funds account 110 and to calculate a net gratuity amount 120 and a service fee amount 122 and to transfer the net gratuity amount 120 to an account associated with a gratuity receiver institution and the service fee amount 122 to an account associated with the service provider 112.

In operation, the computer program instructions running on the server 118 receive the machine-readable code 104 and the indication of the gratuity amount 108 including the gratuity sender source of funds account 110 and calculates a net gratuity amount 120 and a service fee amount 122 and transfers the net gratuity amount 120 to an account associated with a gratuity receiver institution 124 and the service fee amount 122 to an account associated with the service provider 112.

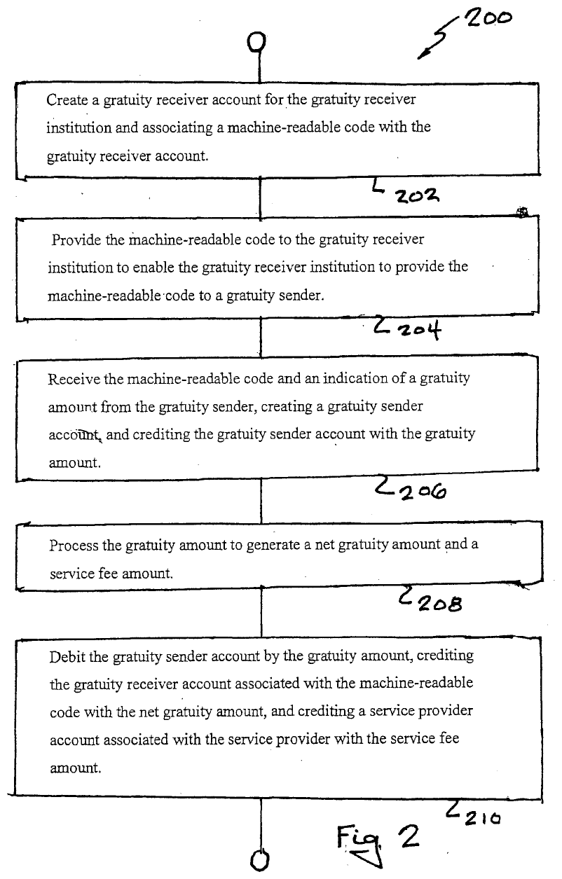

FIG. 2 shows a flow diagram of a computer implemented method 200 for providing a service to receive a gratuity from a gratuity sender and track a net gratuity amount for a gratuity receiver institution and a service fee amount for a service provider in accordance with some embodiments of the present disclosure. The computer-implemented method 200 includes creating a gratuity receiver account for the gratuity receiver institution and associating a machine-readable code with the gratuity receiver account (block 202), providing the machine-readable code to the gratuity receiver institution to enable the gratuity receiver institution to provide the machine-readable code to a gratuity sender (block 204), receiving the machine-readable code and an indication of a gratuity amount from the gratuity sender, creating a gratuity sender account, and crediting the gratuity sender account with the gratuity amount (block 206), processing the gratuity amount to generate a net gratuity amount and a service fee amount (block 208), and debiting the gratuity sender account by the gratuity amount, crediting the gratuity receiver account associated with the machine-readable code with the net gratuity amount, and crediting a service provider account associated with the service provider with the service fee amount (block 210).

In some embodiments, providing the machine-readable code to the gratuity receiver institution to enable the gratuity receiver institution to provide the machine-readable code to the gratuity sender includes providing the machine-readable code on coaster.

In some embodiments, providing the machine-readable code on the coaster includes providing a hologram representation of the machine-readable code.

In some embodiments, providing the hologram representation or the machine-readable code includes providing a color hologram representation of the machine-readable code.

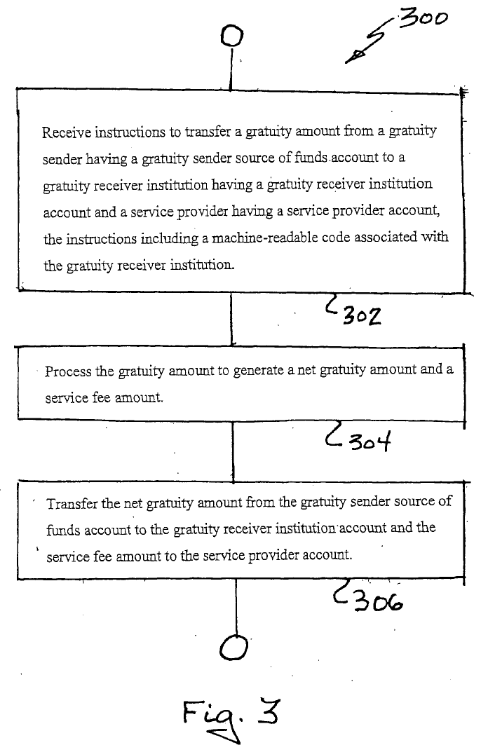

FIG. 3 shows a flow diagram of a computer implemented method 300 for processing a gratuity in accordance with some embodiments of the present disclosure. The computer-implemented method 300 includes receiving instructions to transfer a gratuity amount from a gratuity sender having a gratuity sender source of funds account to a gratuity receiver institution having a gratuity receiver institution account and a service provider having a service provider account, the instructions including a machine-readable code associated with the gratuity receiver institution (block 302), processing the gratuity amount to generate a net gratuity amount and a service fee amount (block 304), and transferring the net gratuity amount from the gratuity sender source of funds account to the gratuity receiver institution account and the service fee amount to the service provider account (block 306). In some embodiments, the computer-implemented method 300 further includes maintaining a running log of transactions for the gratuity receiver institution. In some embodiments, the computer-implemented method 300 further includes maintaining a running log of transactions for the service provider. In some embodiments, the computer-implemented method 300 further includes maintaining a running log of transactions for the gratu8ity sender.

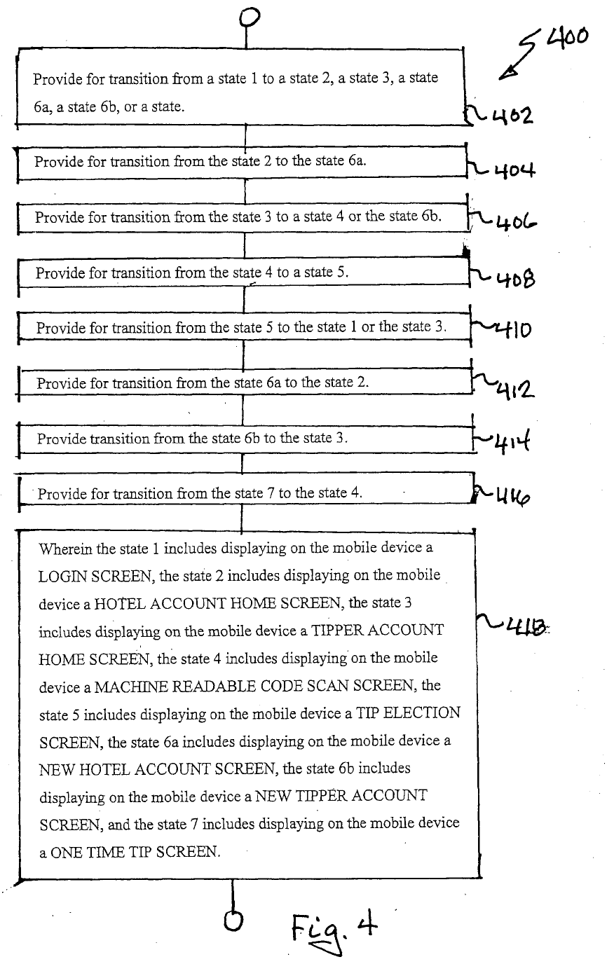

FIG. 4 shows a flow diagram of a computer implemented method 400 for displaying screens in a gratuity collection system in accordance with some embodiments of the present disclosure. The computer-implemented method 400 includes providing for transition from a state 1 to a state 2, a state 3, a state 6a, a state 6b, or a state 7 (block 402), providing for transition from the state 2 to the state 6a (block 404), providing for transition from the state 3 to a state 4 or the state 6b (block 406), providing for transition from the state 4 to a state 5 (block 408), providing for transition from the state 5 to the state 1 or the state 3 (block 410), providing for transition from the state 6a to the state 2 (block 412), providing transition from the state 6b to the state 3 (block 414), and providing for transition from the state 7 to the state 4 (block 416), wherein the state 1 includes displaying on the mobile device a LOGIN SCREEN, the state 2 includes displaying on the mobile device a HOTEL ACCOUNT HOME SCREEN, the state 3 includes displaying on the mobile device a TIPPER ACCOUNT HOME SCREEN, the state 4 includes displaying on the mobile device a MACHINE READABLE CODE SCAN SCREEN, the state 5 includes displaying on the mobile device a TIP ELECTION SCREEN, the state 6a includes displaying on the mobile device a NEW HOTEL ACCOUNT SCREEN, the state 6b includes displaying on the mobile device a NEW TIPPER ACCOUNT SCREEN, and the state 7 includes displaying on the mobile device a ONE TIME TIP SCREEN (block 418).

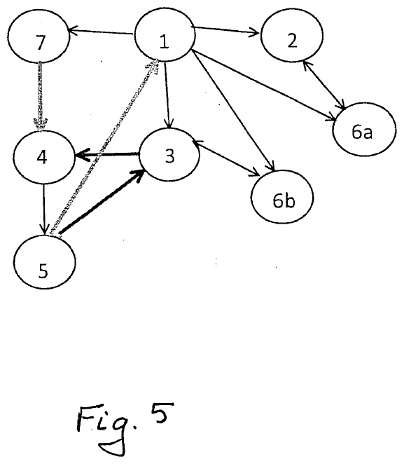

FIG. 5 shows a state diagram for the computer-implemented method for displaying screens in the gratuity collection system shown in FIG. 4 in accordance with some embodiments of the present disclosure.

For a transition from state 1 to state 7, a user transitions from a LOGIN SCREEN to a ONE TIME TIP screen.

For a transition from state 1 to state 3. a user with an existing tipping account transitions from a LOGIN SCREEN to a TIPPER ACCOUNT HOME SCREEN.

For a transition from state 1 to state 2, a user with an existing hotel account transitions from a LOGIN SCREEN to a HOTEL ACCOUNT HOME SCREEN.

For a transition rom state 1 to 6a, a user elects to create a new hotel a count, and the user transitions from a LOGIN SCREEN to a NEW HOTEL ACCOUNT SCREEN.

For a transition from state 1 to state 6b, a user elects to create a new tipper account, and the user transitions from the LOGIN SCREEN to a NEW TIPPER ACCOUNT SCREEN.

For a transition from state 2 to state 6a and back, a user transitions between a HOTEL ACCOUNT HOME SCREENT and a NEW HOTEL ACCOUNT SCREEN.

For a transition from state 3 to state 4, a tipper elects to begin the process for leaving a tip and transitions from a TIPPER ACCOUNT HOME SCREEN to a MACHINE-READABLE CODE SCAN SCREEN.

For a transition from state 3 to state 6b and back, a user transitions between a TIPPER ACCOUNT HOME SCREEN and a NEW TIPPER ACCOUNT SCREEN.

For a transition from state 4 to state 5, once the machine-readable code is scanned, a user transitions from a MACHINE-READABLE CODE SCAN SCREEN to a TIP ELECTION SCREEN.

For a transition from state 5 to state 3, once a tip is selected on a tip election screen, a user transitions from a TIP ELECTION SCREEN to a TIPPER ACCOUNT HOME SCREEN.

For a transition from state 7 to state 4, once information for a one-time tip is input, a user transitions from a ONE TIME TIP SCREEN to a MACHINE-READABLE CODE SCAN SCREEN.

For a transition from stat 5 o state 1, a user transitions from a TIP ELECTION SCREENT to a LOGIN SCREEN.

Further state 2 is the home screen for the hotel account. And state 3 is the home screen for a tipper account.

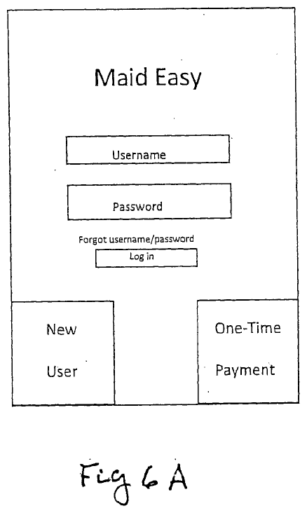

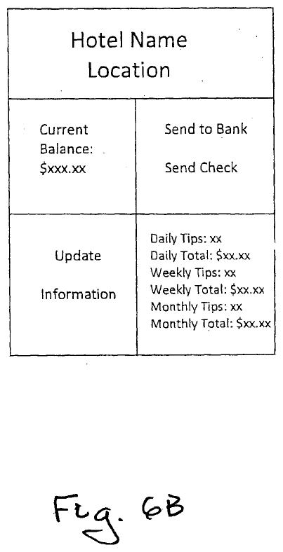

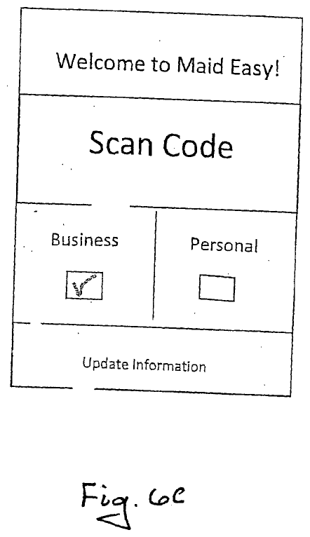

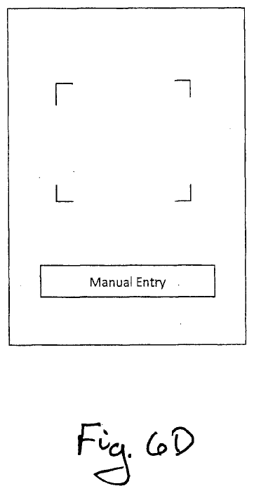

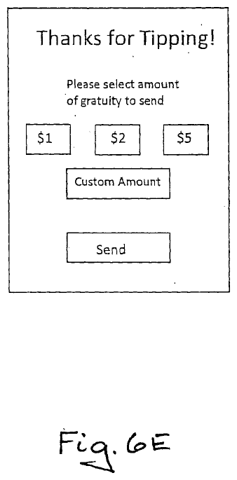

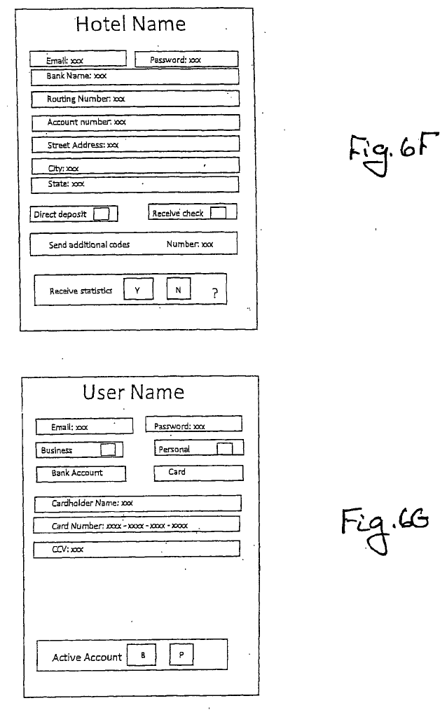

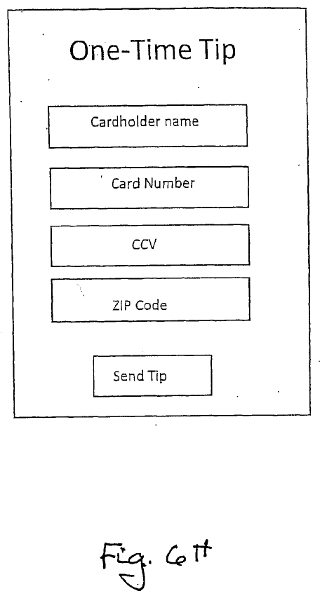

FIGS. 6A, 6B, 6C, 6D, 6E, 6F, 6G, and 6H show exemplary screens suitable for use in connection with implementation of the state diagram shown in FIG. 5 in accordance with some embodiments of the present disclosure.

FIG. 6A shows a LOGIN SCREEN associated with state 1.

FIG. 6B shows a HOTEL ACCOUNT HOME SCREEN associated with state 2.

FIG. 6C shows TIPPER ACCOUNT HOME SCREEN associated with state 3.

FIG. 6D shows a MACHINE-READABLE CODE SCAN SCREEN associated with state 4.

FIG. 6E shows a TIP ELECTION SCREEN associated with state 5.

FIG. 6F shows a NEW HOTEL ACCOUNT SCREEN associated with state 6a.

FIG. 6G shows a NEW TIPPER ACCOUNT SCREEN associated with state 6b.

FIG. 6H shows a ONE TIME TIP SCREEN associated with state 7.

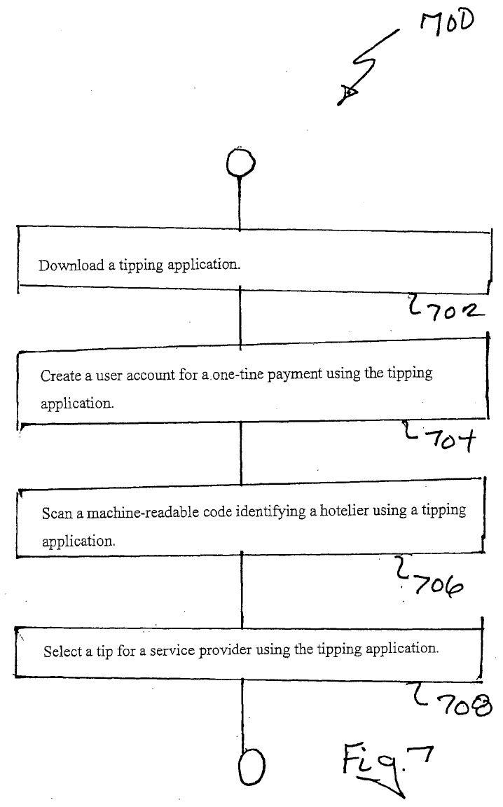

FIG. 7 shows a computer-implemented method 700 for tipping a service provider in accordance with some embodiments of the present disclosure. The computer-implemented method 700 includes downloading a tipping application (block 702), creating a user account for a one-tine payment using the tipping application (block 704), scanning a machine-readable code identifying a hotelier using the tipping application (bock 706), and selecting a tip for the service provider using the tipping application (block 708). In some embodiments, selecting the tip for the service provider using the tipping application includes selecting an option to provide the tip in cryptocurrency. In some embodiments, the method further includes receiving the one-time payment by a team lead and the team lead routes a service provider tip to one or more service providers.

FIG. 8 shows exemplary information for collection at the NEW HOTEL ACCOUNT SCREEN shown in FIG. 6F in accordance with some embodiments of the present disclosure.

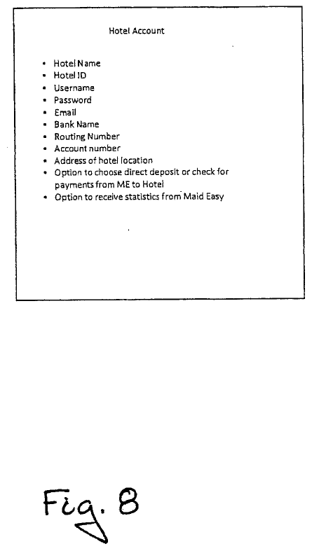

FIG. 9 shows exemplary information for collection at the NEW TIPPER ACCOUNT SCREEN shown in FIG. 6G in accordance with some embodiments of the present disclosure.

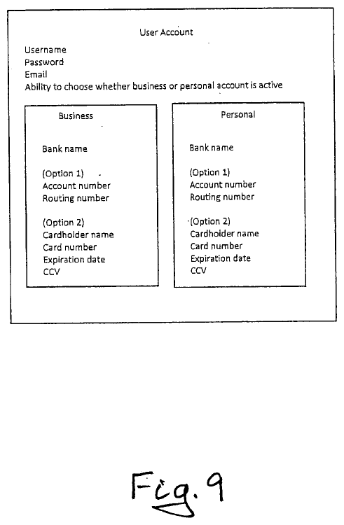

FIG. 10 shows an exemplary coaster layout for the system shown in FIG. 1B in accordance with some embodiments of the present disclosure.

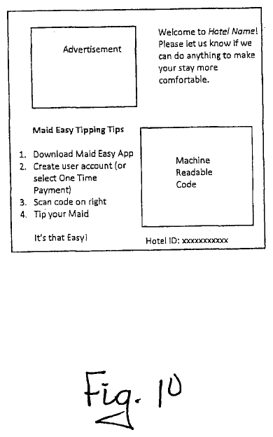

FIG. 11 shows a block diagram of one embodiment of the mobile computing device 102 shown in FIG. 1A in accordance with some embodiments of the present disclosure. The mobile computing device 102 includes one or more processors 1102, one or more memory systems 1104, a communications system 1106, one or more input/output ports 1108, a power system 1110, and a bus 1112. The one or more processors 1102 are not limited one type of processor or a particular processor. Exemplary processors suitable for use in the mobile computing device 102 include complex instruction set processors and reduced instruction set processors among others. The one or more memory systems 1104 includes integrated circuit memory, such as dynamic random-access memory, and magnetic or optical memory. The communications system 1106 include digital and analogue communication systems, such as digital radio systems or analog radio systems. The one or more input/output ports 1108 include circuits and systems for coupling the mobile computing device 102 to other systems. The power 1108 includes direct-current and alternating current derived power for delivering energy to the mobile computing device 102. The bus 1112 provides coupling among the one or more processors 1102, the one or more memory systems 1104, the communication system 1106, the one or more input/output ports 1108, the power 1110 and the bus 1112.

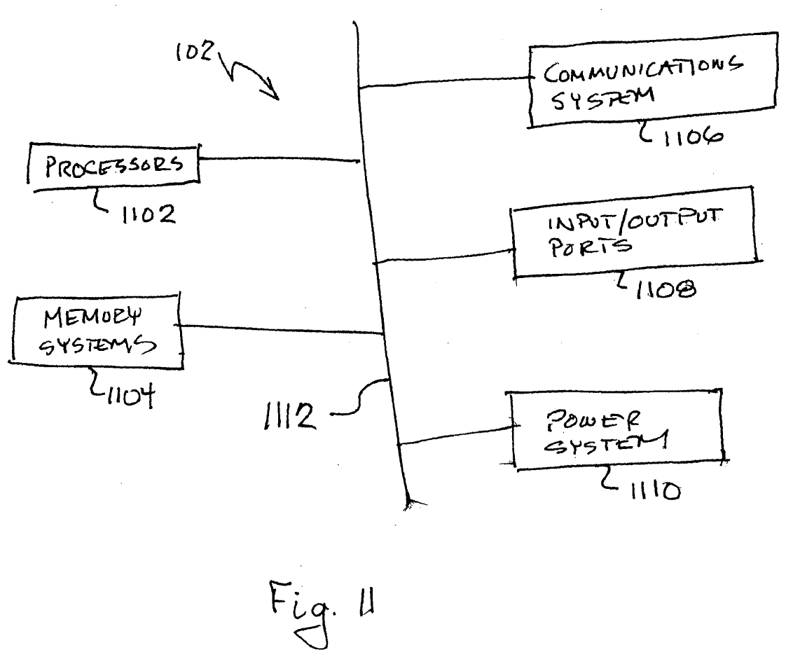

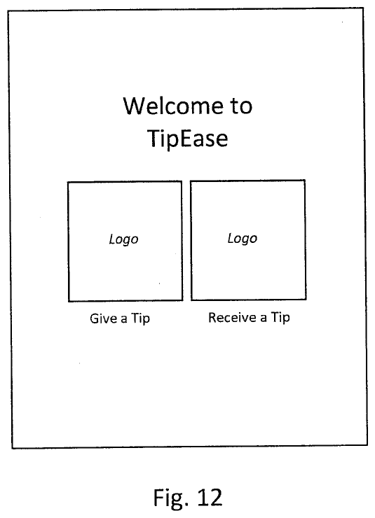

FIG. 12 shows an illustration of Screen 1, New User Landing, in accordance with some embodiments of the present disclosure.

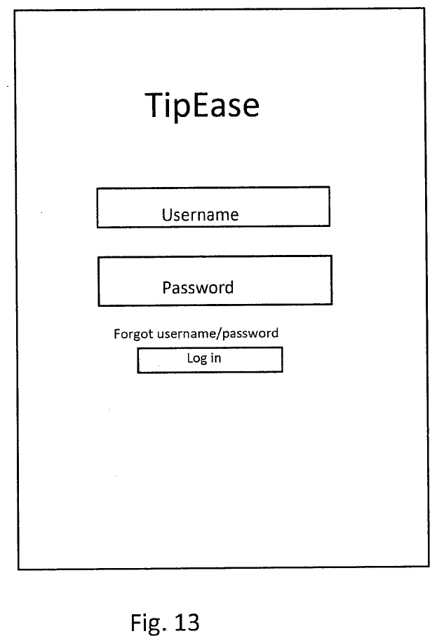

FIG. 13 shows an illustration of Screen 2, Existing User Login, in accordance with some embodiments of the present disclosure.

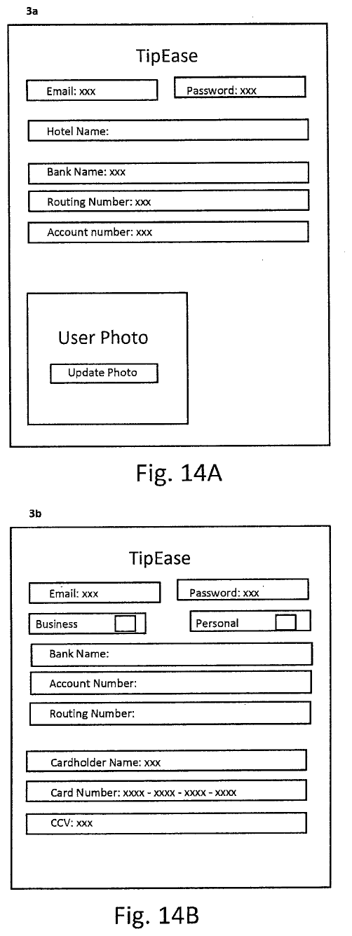

FIGS. 14A to 14B shows an illustration of Screen 3a and 3b, New Accounts, in accordance with some embodiments of the present disclosure.

The fields of Screen 3a, the Housekeeper Account screen of New Accounts includes:
Email: Collects user's email.
Password: Collects user's password.
Hotel Name: Displays name of hotel that housekeeper is a member of
Bank Name, Routing Number, Account Number: Collects relevant bank information.
User Photo: Collects user photo (optional).

The fields of Screen 3b, the New Tipper Account screen of New Accounts includes:
Email: Collects user's email
Password: Collects user's password.
Business/Personal Checkboxes: Allows new user to select if they are inputting business or personal account information.
Bank Name, Routing Number, Account Number: Collects relevant bank information Card Holder Name, Card Number, CCV: Collects card information if user wishes to have credit card on file.

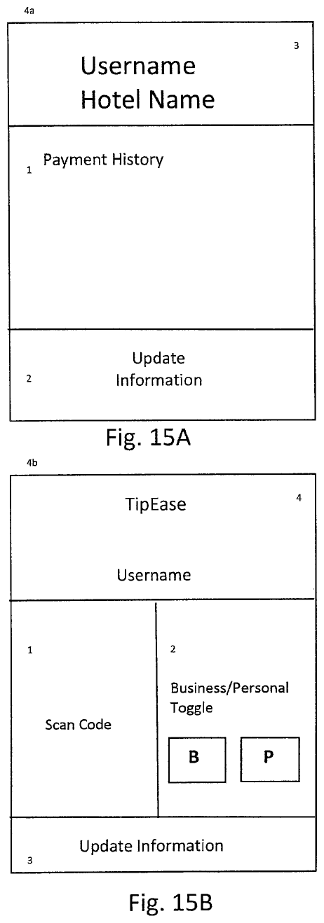

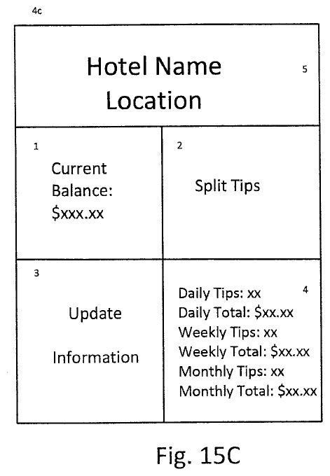

FIGS. 15A to 15C shows an illustration of Screen 4a, 4b, and 4c, User Home Pages, in accordance with some embodiments of the present disclosure.

The fields of Screen 4a, the Housekeeper Home Page screen of User Home Pages includes:
Box 1: Running tally of history of payments made to housekeepers by hotel team lead.
Box 2: Sends user to update information screen (screen 5a).
Box 3: Displays Housekeeper username and Hotel name.

The fields of Screen 4b, the Tipper Home Page screen of User Home Pages includes:
Box 1: Takes user to Scan Code screen (screen 6).
Box 2: Toggle between business and personal accounts.
Box 3: Sends user to update information screen (screen 5a).
Box 4: Displays TipEase logo and Username.

The fields of Screen 4c, the Hotel Team Lead Home Page screen of User Home Pages includes:
Box 1: displays up-to-date balance of tips received minus service change.
Box 2: Takes team lead to split tips screen (screen 9).
Box 3: Sends user to information update screen (screen 5c).
Box 4: Displays daily, weekly, and monthly number of tips sent at that hotel and total amount of tips in dollars sent at that hotel. If clicked, that section enlarges to full screen for easier visibility.
Box 5: Displays name of hotel (eg La Quinta) and Location (eg Denver, CO Hotel Team Lead Home Page.

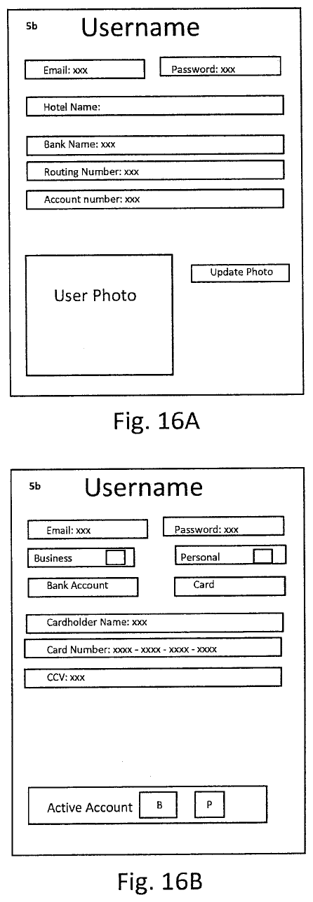

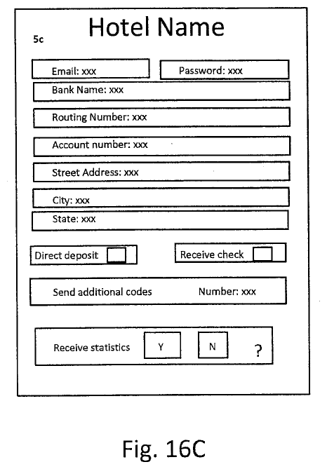

FIGS. 16A to 16C shows an illustration of Screens 5a, 5b, and 5c, Information Update, in accordance with some embodiments of the present disclosure.

The fields of Screen 5a, the Housekeeper Info Update screen of Information Update includes:
Username displays at top of page.
Email: allows user to change active email.
Password: allows user to change password Bank Name, Routing Number, Account Number: Allows user to change bank information on file.
User Photo: Displays current user photo.
Update Photo: Update user photo.

The fields of Screen 5b, the Tipper Info Update screen of Information Update includes:
Username displays at top of page.
Email: allows user to change active email.
Password: allows user to change password.
Business/Personal: switches which information will be updated. Only one can be selected at once. Box turns dark blue when selected. Bank Account/Card: if bank account selected, user will be asked for bank name, routing number, and account number. If card selected, user will be asked for cardholder name, card number, and CCV. Card option showed
Cardholder name: change name on card for selected business or personal Card number: Change card number for selected b or p CCV: Change CCV for selected b or p Active account: toggle between accounts for which is active account when making payments.

The fields of Screen 5c, the Hotel Team Lead Info Update screen of Information Update includes:
Hotel Name displays at top of page.
Bank Name: name of bank used by hotel Routing number: hotel's bank account routing number Account number: hotel's bank account routing number.
Street Address: Street address of hotel.
City: City of hotel.
State: State of hotel.
Direct deposit/receive check: only one of these can be checked at one time. Selects whether hotel will receive payment by direct deposit or paper check. Box that is selected appears as dark blue.
Send additional codes: allows hotel to request additional codes to place in rooms. Number section will have drop down menu of 100, 200, 300, 400, 500, 1000, 2000, 5000 options.
Receive statistics: Y or N can be selected, one must be selected at all times and only one can be selected. Will dictate whether hotel receives statistics by email of recent tip activity or not. Statistics will include breakdown of tips received by day, week, and month. Also includes breakdown of amount received by day, week, month. Average size of tip calculated daily, weekly, monthly. Quarterly reports and Yearly reports will include quarterly stats and yearly stats. Question mark brings up description of statistics offered. Selected box shows as dark blue.

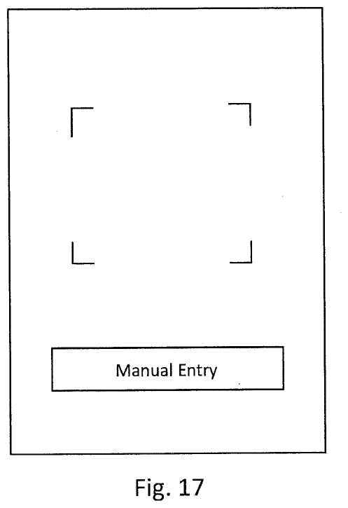

FIG. 17 shows an illustration of Screen 6, MRC Scan, in accordance with some embodiments of the present disclosure. The whole screen is using camera to scan Machine Readable Code. Rear camera of device is default camera used. Manual Entry box is for entering code for hotel if scanner not working. Box is white with black text to stand out from background of camera input.

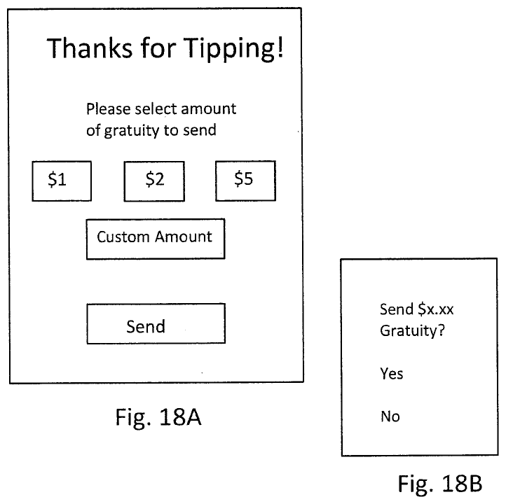

FIGS. 18A and 18B show an illustration of Screen 7, Tip Election Screen, and an illustration of Screen 7a, Verification Screen, in accordance with some embodiments of the present disclosure; $1, $2, $5 boxes start light blue, and get darker blue if user clicks on that box to signify that is the amount that they have selected. Custom amount brings up number keyboard from phone for user to select their own tip amount. After amount selected, that box turns darker blue to signify that custom amount has been selected. Amount inputted displays in custom amount box.

Send button brings up screen 7a.

Amount selected on screen 5 displays for user to confirm.

Selecting “Yes” sends gratuity from user's account to Maid Easy account. User then transferred back to screen 3.

Selecting “No” sends user back to screen 5.

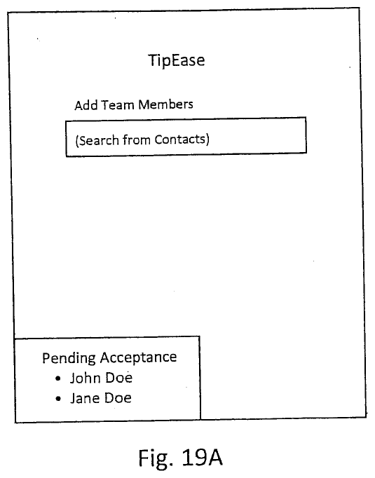

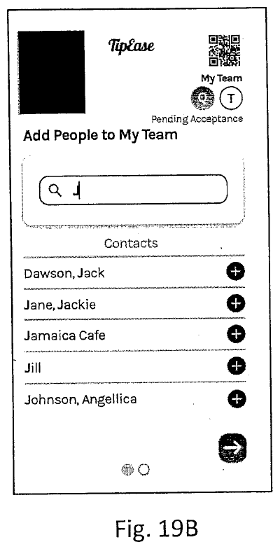

FIGS. 19A and 19B show an illustration of Screen 8, New Housekeepers, and a related screen in accordance with some embodiments of the present disclosure.

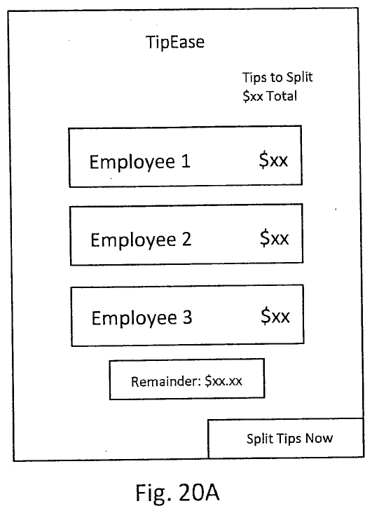

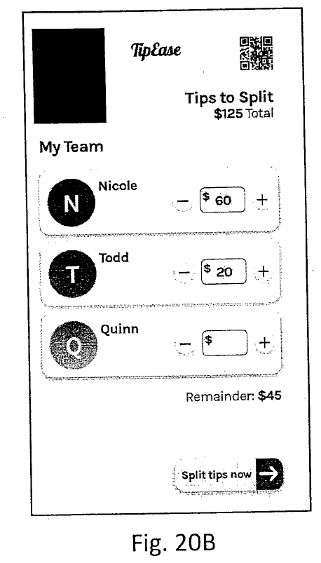

FIGS. 20A and 20B show an illustration of Screen 9, Split Tips, and a related screen in accordance with some embodiments of the present disclosure.

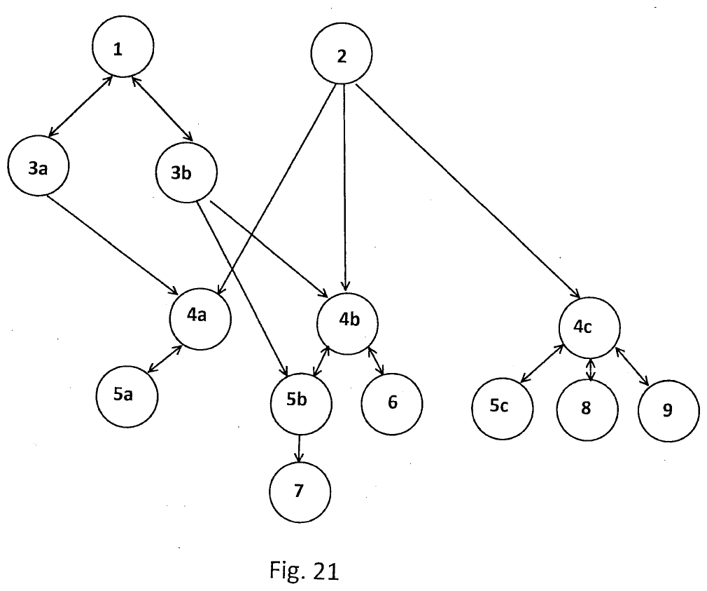

FIG. 21 shows a state diagram of transitions among Screens 1 to 9 in accordance with some embodiments of the present disclosure.

### Screens

1. New User Landing Screen
2. Existing User Login
3. New Accounts
   a. Housekeeper
   b. Tipper
4. User Home Pages
   a. Housekeeper
   b. Tipper
   c. Hotel Team Lead
5. Information Update
   a. Housekeeper
   b. Tipper
   c. Hotel Team Lead
6. Machine Readable Code Scan Screen
7. Tip Election Screen
8. Invite New Team Members
9. Split Tips Screen

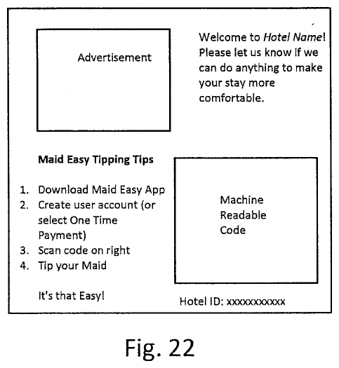

FIG. 22 shows an illustration of an MRC Card in accordance with some embodiments of the present disclosure.
Background: Light Green.
Text: Black.
Advertisement: whatever color advertiser selects.
Code: black and white.
Dimensions:
4 in×4 in×1.4 mm 1.4 mm is “medium strength” of standard coaster.
In some embodiments, material: card is made of cardboard and presented as coffee coaster. Coaster coated in material that can be sanitized to remove viruses, bacteria. Card will be made to ensure reusability, and also so that it is recyclable once hotel goes to discard code. Two or three coasters are distributed to each room. Ideal placement locations include desk, nightstand, tv stand.

Top Left: Advertisement for local business. That section of the card will say something to the effect of “flip over for great deals from local advertiser.” Back side of card is advertisement for that advertiser. Top Right: Welcome to hotel message. Hotels can individualize this message to say anything along the lines of “welcome to the hotel, let us know if we can help make your stay better” Bottom Left: Simplified instructions for how to use app. Instructions kept short and choppy as displayed on left to show simplicity of using app.

Bottom Right: Machine readable code. Below code is hotel's ID in case code is not readable so that user can manually input.

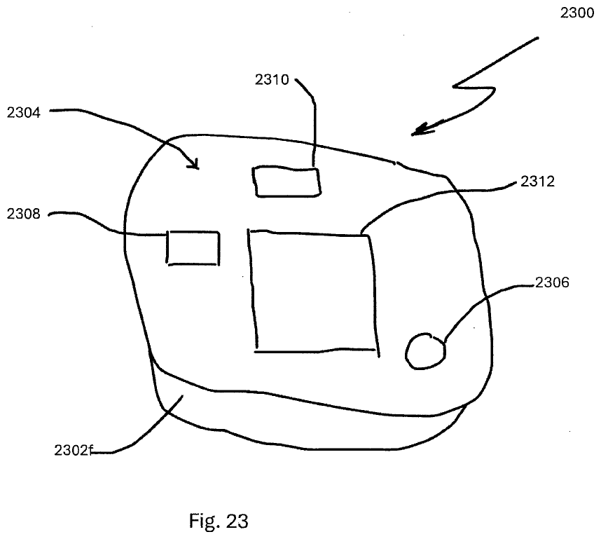

FIG. 23 shows an illustration of a device 2300 in accordance with some embodiments of the present disclosure. The device 2300 includes a coaster or other structure 2302. The coaster or other structure 2302 is not limited to being formed from a particular material. In some embodiments, the coaster or other structure 2302 are formed from a recyclable material. Example recyclable materials include plastics, fabrics, denim, and cork. The coaster or other structure 2302 has a surface 2304 and a security hologram 2306 formed on the surface 2304. The security hologram 2306 prevents others from creating imitation or fraudulent coasters or other structures. The security hologram 2306 is a diffractive optical device used to verify authenticity and prevent counterfeiting by including features like microtext, laser-viewable images, or tamper-evident materials that reveal a “VOID” message if removed, ensuring authenticity of the coaster or other structure 2302. Because the device 2300 is used in a financial transaction, it's important to have security measures in place to avoid hackers and others who might seek access to the systems described herein. A machine readable code 2308 is formed on the surface 2304 and an advertisement 2310 is included in the coaster or other structure. 2302. In some embodiments, the device 2300 includes an antimicrobial material 2312 formed on the surface 2304, the antimicrobial material 2312 provides a prophylaxis. As used herein, an antimicrobial material includes antiviral materials. In some embodiments, the antimicrobial material kills Escherichia coli.Example antimicrobial materials suitable for use as the antimicrobial material 2312 include metals, such as copper, silver, and gallium, polymers, for example, titanium dioxide, zinc oxide, and magnesium oxide, antimicrobial polymers, for example, chitosan, quaternary ammonium polymers, and polyhexamethylene biguanide, and coatings that include silver nanoparticles and carbon nanotubes. In some embodiments, the antimicrobial material 2312 covers substantially all the surface 2304.

A method for creating one or more computer programs for a system for providing a gratuity to a service provider in a motel or hotel is disclosed. The method includes selecting an artificial intelligence code generating system, and prompting the artificial intelligence code generating system with one or more prompts to generate one or more computer program for the system for providing the gratuity to the service provider in the motel or hotel. Example artificial intelligence code generating systems suitable for use in connection with embodiments included in the disclosure include Copilot, Codex, and Gemini Code Assist.

In some embodiments, when prompting the artificial intelligence code generating system with one or more prompts to generate the one or more computer programs for the system for providing the gratuity to the service provider in the motel or hotel the method includes providing the one or more prompts to effect at least the following method: reading a security hologram from a coaster or other structure using a communication device; verifying the security hologram in the communication device; terminating the program if the security hologram is not verified; and passing information from the communication device to a server, if the security hologram is verified. Reading the security hologram 2306 (shown in FIG. 23) and validating the security hologram at the communication device speeds the processing in the overall system by avoiding the cost of uploading the hologram to a server and having verification done at the server. This saves network bandwidth, time, and server cycles, thus improving the overall performance of the system.

Reference throughout this specification to “an embodiment,” “some embodiments,” or “one embodiment.” means that a particular feature, structure, material, or characteristic described in connection with the embodiment is included in at least one embodiment of the present disclosure. Thus, the appearances of the phrases such as “in some embodiments,” “in one embodiment,” or “in an embodiment,” in various places throughout this specification are not necessarily referring to the same embodiment of the present disclosure. Furthermore, the particular features, structures, materials, or characteristics may be combined in any suitable manner in one or more embodiments.

Although explanatory embodiments have been shown and described, it would be appreciated by those skilled in the art that the above embodiments cannot be construed to limit the present disclosure, and changes, alternatives, and modifications can be made in the embodiments without departing from spirit, principles and scope of the present disclosure.

What is claimed is:

1. A device comprising:
a coaster or other structure, the coaster or other structure formed from a recyclable material, the coaster or other structure having a surface and a security hologram formed on the surface, a machine readable code formed on the surface, and an advertisement included in the coaster or other structure.

2. The device of claim 1, further comprising an antimicrobial material formed on the surface, the antimicrobial material to provide a prophylaxis.

3. The device of claim 2, wherein the antimicrobial material kills Escherichia coli.

4. A method for creating one or more computer programs for a system for providing a gratuity to a service provider in a motel or hotel, the method comprising:
selecting an artificial intelligence code generating system; and
prompting the artificial intelligence code generating system with one or more prompts to generate one or more computer program for the system for providing the gratuity to the service provider in the motel or hotel.

5. The method of claim 4, wherein prompting the artificial intelligence code generating system with one or more prompts to generate the one or more computer programs for the system for providing the gratuity to the service provider in the motel or hotel comprises providing the one or more prompts to effect at least the following method:
reading a security hologram from a coaster or other structure using a communication device;
verifying the security hologram in the communication device;
terminating the program if the security hologram is not verified; and
passing information from the communication device to a server, if the security hologram is verified.

6. A system comprising:
a mobile computing device including one or more processors and a memory holding computer program instructions executable by the one or more processors to read a machine-readable code in a hotel room and transmit the machine-readable code and an indication of a gratuity amount including a gratuity sender source of funds account to a service provider, wherein a coaster includes the machine-readable code, the coaster includes a recyclable material, the recyclable material includes a surface that repels viruses, the machine-readable code includes a security hologram, and the coaster includes an advertisement.
